(19) United States
(12) Patent Application Publication
(10) Pub. No.: US 2026/0125541 A1
(43) Pub. Date: May 7, 2026

(54) RESIN COMPOSITION, METHOD FOR ITS PREPARATION AND ARTICLES PREPARED THEREFROM

(71) Applicant: Carysil Limited, Mumbai - Maharashtra (IN)

(72) Inventors: Chirag Ashwinbhai PAREKH, Bhavnagar, Gujarat (IN); Dhruv Jagdishbhai ANDHARIA, Bhavnagar, Gujarat (IN); Ankita SHARMA, Bhavnagar, Gujarat (IN)

(73) Assignee: Carysil Limited, Mumbai - Maharashtra (IN)

(21) Appl. No.: 19/117,142

(22) PCT Filed: Aug. 3, 2023
(86) PCT No.: PCT/IB2023/057860

§ 371 Date: Mar. 31, 2025

(30) Foreign Application Priority Data
Aug. 3, 2022 (IN) 202221044385

(51) Int. Cl. C08L 1/28; C08K 3/34; C08K 3/36; C08K 5/5419

(52) U.S. Cl. CPC C08L 1/286; C08K 3/36; C08K 5/5419; C08K 2003/343; C08K 2201/005

(57) ABSTRACT

The present disclosure relates to a resin composition, a method for the preparation of the resin composition and articles prepared therefrom. The resin composition of the present disclosure comprises a resin, a filler, an additive, optionally a coupling agent and a curing agent. The resin composition of the present disclosure is easy to prepare, requires a lesser amount of resin and has increased flowability. The process for the preparation of the resin composition is simple, economical and environment friendly. The articles prepared using the resin composition of the present disclosure have higher strength and can be moulded with lower thicknesses while retaining the desired strength. Further, the articles are durable and have enhanced life expectancy, are weather resistant and eco-friendly.

### FIELD

THE PRESENT DISCLOSURE RELATES TO A RESIN COMPOSITION, A METHOD FOR ITS PREPARATION AND ARTICLES PREPARED THEREFROM.

### Definitions

As used in the present disclosure, the following terms are generally intended to have the meaning as set forth below, except to the extent that the context in which they are used indicates otherwise.

Casting: The term ‘casting’ refers to a process comprising pouring of a material into a mould, where it solidifies into the shape of the mould.

Curing: The term ‘curing’ refers to a process where a molded object is set by providing the right moisture, temperature and time. This allows the molded product/article to attain the desired properties for its intended use.

Compression strength: The term ‘compression strength’ refers to the maximum compressive stress that a solid material can withstand without fracturing under gradually applied load.

Tensile strength: The term ‘tensile strength’ refers to the measurement of the force that can be applied to a material before it yields (stretches irreparably) or breaks.

Flexural strength: The term ‘flexural strength’ pertains to a material's capacity to withstand deformation when subjected to a load. It quantifies the amount of force needed to fracture an article with a specified diameter.

Flowability: The term ‘flowability’ refers to the ability of a resin composition to flow easily and smoothly, allowing it to fill and mold intricate shapes or cavities with minimal resistance. It is a measure of the composition's fluidity and workability, indicating how well it can be poured, pumped, or extruded into desired forms during manufacturing processes.

Pot life: The term ‘pot life’ refers to the length of time that a workable paste retains its consistency, enough to be used for moulding. It is also known as working time or usable life.

Compressive strength: The term ‘compressive strength’ refers to the maximum stress a material can sustain under crush loading.

Binding agent: The term ‘binding agent’ refers to a substance that holds or draws other materials together mechanically, chemically, or as an adhesive, to form a cohesive unit.

Filler: The term ‘filler’ refers to a substance that is added to create the required volume and reduce consumption of expensive material.

Engineered stone: The term ‘engineered stone’ refers to a composite material comprising crushed stone combined with an adhesive, forming a durable and solid surface. This composite is typically bound using polymer resin.

Agglomerate stones: The term ‘agglomerated stone’ describes a material made by blending mechanically fragmented stone material with a cementitious binder to create a compact substance. This compact material can then be cut into slabs, tiles and other architectural elements.

### BACKGROUND

The background information herein below relates to the present disclosure but is not necessarily prior art.

Natural stones such as marble, granite, quartz and the like have been used in flooring, wall panels, sinks and the like for architectural decoration due to their strengths and durability. In the modern construction industry, these stones are typically used in countertops, vanity tops, sinks, bathtubs, showers, flooring tiles and walls for bathroom and/or kitchen, bathroom partitions and the like. They are generally used where water resistance and hygiene are of importance along with aesthetics. Thus, natural stones having a high-quality texture are in huge demand in the construction industry.

Since these stones are naturally obtained, chiseling them to the desired shape or size is a tedious task. Further, to cater to specific requirements and transportation are other issues.

Hence, to meet the demands of the ever-growing construction industry, different types of agglomerated stones or engineered stones have been developed and used. These agglomerated stones or engineered stones have textures and properties similar to natural stones. However, articles made of these engineered stones are required to have comparatively higher thicknesses to meet the desired strength. Additionally, the current production process consumes a significant amount of resin, leading to cost inefficiencies.

Another concern is the transportation of articles made from conventional resins, as they are more susceptible to damage during transit due to their relatively lower strength.

Therefore, there is felt a need to provide a resin composition, a method for its preparation and articles made therefrom that overcome the above-mentioned drawbacks or at least provide a useful alternative.

### OBJECTS

Some of the objects of the present disclosure, which at least one embodiment herein satisfies, are as follows.

IT IS AN OBJECT OF THE PRESENT DISCLOSURE TO AMELIORATE ONE OR MORE PROBLEMS OF THE PRIOR ART OR TO AT LEAST PROVIDE A USEFUL ALTERNATIVE.

Another object of the present disclosure is to provide a resin composition.

Still another object of the present disclosure is to provide a resin composition that improves the strength of an article, when cast therefrom and cured.

Yet another object of the present disclosure is to provide a resin composition which requires comparatively lesser amount of resin.

Still another object of the present disclosure is to provide a resin composition which is cost-effective and environment friendly.

Still another object of the present disclosure is to provide a resin composition with improved flowability.

Yet another object of the present disclosure is to provide a resin composition with improved binding property.

Still another object of the present disclosure is to provide a process for the preparation of a resin composition.

Yet another object of the present disclosure is to provide a simple, economic and environment-friendly process for the preparation of the resin composition.

Yet another object of the present disclosure is to provide an article made of the resin composition.

Still another object of the present disclosure is to provide an article that has improved strength.

Yet another object of the present disclosure is to provide an article which can be cast with comparatively lesser thickness.

OTHER OBJECTS AND ADVANTAGES OF THE PRESENT DISCLOSURE WILL BE MORE APPARENT FROM THE FOLLOWING DESCRIPTION, WHICH IS NOT INTENDED TO LIMIT THE SCOPE OF THE PRESENT DISCLOSURE.

### SUMMARY

The present disclosure relates to a resin composition, a process for its preparation and articles made therefrom.

In an aspect the present disclosure relates to a resin composition. The resin composition comprises a resin in an amount in the range of 5 mass % to 30 mass % with respect to the total mass of the composition, a filler in an amount in the range of 70 mass % to 90 mass % with respect to the total mass of the composition, an additive in an amount in the range of 0.1 mass % to 10 mass % with respect to the total mass of the composition, wherein the additive comprises a predetermined amount of a mineral clay and a predetermined amount of a cellulose derivative, optionally a coupling agent in an amount in the range of 0.5 mass % to 3 mass % with respect to the total mass of the composition and optionally a curing agent in an amount in the range of 0.02 mass % to 0.09 mass % with respect to the total mass of the composition.

In accordance with the present disclosure, the resin is at least one selected from the group consisting of acrylic resin, epoxy resin, polycarbonate resin, vinyl ester resin, polyamide resin, polymethylmethacrylate resin and polyester resin.

In accordance with the present disclosure, the filler is at least one selected from the group consisting of quartz, olivine, feldspar, pyroxene, mica, granite, ceramics and metals.

In accordance with the present disclosure, the filler is in the form of particles and predominant quantity of the particles have a particle size in the range of 0.06 mm to 0.8 mm.

In accordance with the present disclosure, the filler is in the form of particles and predominant quantity of the particles have particle size in the ranges of 0.06 mm to 0.1 mm, 0.1 mm to 0.3 mm and 0.3 mm to 0.7 mm.

In accordance with the present disclosure, the mineral clay is at least one selected from the group consisting of magnesium silicate hydrate gel, kaolinite and bentonite.

In accordance with the present disclosure, the cellulose derivative is at least one selected from the group consisting of ethyl cellulose, methyl cellulose, carboxymethyl cellulose, hydroxyethyl cellulose and hydroxypropyl cellulose.

In accordance with the present disclosure, the coupling agent is at least one selected from the group consisting of γ-(Methacryl oxyl) propyl tri methoxy silane and γ-(2, 3-epoxy propoxy) propyl tri methoxy silane.

In accordance with the present disclosure, the curing agent is at least one selected from the group consisting of peroxide, benzoyl peroxide, lauryl peroxide, 2,2-azo-bis-isobutyrylnitrile and tert-Butyl peroxy benzoate.

In accordance with the present disclosure, the predetermined amount of the mineral clay to the predetermined amount of the cellulose derivative has a mass ratio in the range of 1:1 to 1:10 In accordance with the present disclosure, the predetermined amount of the mineral clay to the predetermined amount of the cellulose derivative has a mass ratio in the range of 1:1 to 1:4.

In accordance with the present disclosure, the resin is characterized by having flowability in the range of 6.0 kg/min to 9.0 kg/min.

In accordance with the present disclosure, the resin is characterized by having mechanical strength measured by the pot drop test wherein an article made from the composition resists breaking from a height of up to 270 cm.

In another aspect, the present disclosure relates to a process for the preparation of a resin composition. The process comprises the steps of blending a mineral clay and a cellulose derivative in a predetermined mass ratio to obtain an additive of a predetermined amount. The predetermined amount of the additive is mixed with a filler, a resin and optionally a coupling agent and a curing agent is added to form a mixture. The mixture is then introduced in a blender and is subsequently subjected to blending at a speed in the range of 100 rpm to 200 rpm for a time period in the range of 10 minutes to 55 minutes to obtain the resin composition

In still another aspect, the present disclosure relates to a process for preparing an article using the resin composition comprises pouring the composition in a hot press mould and heating at a temperature in the range of 170° C. to 190° C. for a time period in the range of 50 minutes to 55 minutes to obtain a preform. Thereafter, the preform is removed from the mould, followed by curing at a temperature in the range of 170° C. to 190° C. for a time period in the range of 50 minutes to 60 minutes to obtain the article.

### DETAILED DESCRIPTION

THE PRESENT DISCLOSURE RELATES TO A RESIN COMPOSITION, A METHOD FOR ITS PREPARATION AND ARTICLES PREPARED THEREFROM.

Embodiments, of the present disclosure, will now be described herein detail.

Embodiments are provided so as to thoroughly and fully convey the scope of the present disclosure to the person skilled in the art. Numerous details, are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

In the construction industry, stones such as marble, granite, quartz are typically used in countertops, vanity tops, sinks, bathtubs, showers, flooring tiles and walls for bathroom and/or kitchen, bathroom partitions, and the like. They are generally used where water resistance and hygiene are of importance along with the aesthetics. Thus, natural stones having a high-quality texture are in huge demand in the construction industry. Since these stones are naturally obtained, chiseling them to the desired shape or article is a tedious task. Further, to cater for the specific requirement, transportation is another issue. Hence, to meet the demands of the ever-growing construction industry, different types of agglomerated stones or engineered stones have been developed and used. These agglomerated stones or engineered stones have textures and properties similar to natural stones. However, the articles made up of these existing engineered stones are required to have comparatively higher thicknesses to meet the desired strengths. Furthermore, a significant amount of resin is consumed in the preparation of these articles, and the use of the resin is not cost-effective.

The present disclosure provides a resin composition, a method for the preparation of the resin composition and articles prepared therefrom.

In an aspect of the present disclosure, there is provided a resin composition.

The resin composition comprises a resin in an amount in the range of 5 mass % to 30 mass % with respect to the total mass of the composition, a filler in an amount in the range of 70 mass % to 90 mass % with respect to the total mass of the composition, an additive in an amount in the range of 0.1 mass % to 10 mass % with respect to the total mass of said composition, wherein the additive comprises a predetermined amount of a mineral clay and a predetermined amount of a cellulose derivative, optionally a coupling agent in an amount in the range of 0.5 mass % to 3 mass % with respect to the total mass of the composition, and optionally a curing agent in an amount in the range of 0.02 mass % to 0.09 mass % with respect to the total mass of the composition.

In accordance with the present disclosure, the resin is at least one a selected from the group consisting of acrylic resin, epoxy resin, polycarbonate resin, vinyl ester resin, polyamide resin, polymethylmethacrylate resin and polyester resin.

In an exemplary embodiment, the resin is acrylic resin.

In an another exemplary embodiment, the resin is polymethylmethacrylate resin.

In another exemplary embodiment, the resin is epoxy resin.

In another exemplary embodiment, the resin is polycarbonate resin.

In another exemplary embodiment, the resin is vinyl ester resin.

In another exemplary embodiment, the resin is polyamide resin.

In another exemplary embodiment, the resin is polyester resin.

In an exemplary embodiment, the predetermined amount of resin is 5 mass % with respect to the total mass of the composition.

In another exemplary embodiment, the predetermined amount of resin is 10 mass % with respect to the total mass of the composition.

In another exemplary embodiment, the predetermined amount of resin is 20 mass % with respect to the total mass of the composition.

In another exemplary embodiment, the predetermined amount of resin is 30 mass % with respect to the total mass of the composition.

In accordance with the present disclosure, the filler is at least one selected from the group consisting of quartz, olivine, feldspar, pyroxene, mica, granite, ceramics and metals.

In an exemplary embodiment, the filler is quartz.

In another exemplary embodiment, the filler is olivine.

In another exemplary embodiment, the filler is feldspar.

In another exemplary embodiment, the filler is pyroxene.

In another exemplary embodiment, the filler is mica.

In another exemplary embodiment, the filler is granite.

In another exemplary embodiment, the filler is ceramics.

In another exemplary embodiment, the filler is metals.

In an exemplary embodiment, the predetermined amount of filler is 70 mass % with respect to the total mass of the composition.

In an exemplary embodiment, the predetermined amount of filler is 75 mass % with respect to the total mass of the composition.

In another exemplary embodiment, the predetermined amount of filler is 80 mass % with respect to the total mass of the composition.

In an exemplary embodiment, the predetermined amount of filler is 85 mass % with respect to the total mass of the composition.

In an exemplary embodiment, the predetermined amount of filler is 90 mass % with respect to the total mass of the composition.

In accordance with the present disclosure, the filler is in the form of particles and predominant quantity of the particles have a particle size in the range of 0.06 mm to 0.8 mm.

In accordance with the present disclosure, the filler is in the form of particles and predominant quantity of the particles have particle size in the ranges of 0.06 mm to 0.1 mm, 0.1 mm to 0.3 mm and 0.3 mm to 0.7 mm.

In accordance with the present disclosure, the mineral clay is at least one selected from the group consisting of magnesium silicate hydrate gel, kaolinite and bentonite.

In an exemplary embodiment, the mineral clay is magnesium silicate hydrate gel.

In another exemplary embodiment, the mineral clay is kaolinite.

In an exemplary embodiment, the mineral clay is bentonite.

In accordance with the present disclosure, the cellulose derivative is at least one selected from the group consisting of ethyl cellulose, methyl cellulose, carboxymethyl cellulose, hydroxyethyl cellulose, hydroxypropyl cellulose.

In an exemplary embodiment, the cellulose derivative is carboxymethyl cellulose.

In another exemplary embodiment, the cellulose derivative is ethyl cellulose

In another exemplary embodiment, the cellulose derivative is methyl cellulose

In another exemplary embodiment, the cellulose derivative is hydroxyethyl cellulose.

In another exemplary embodiment, the cellulose derivative is hydroxypropyl cellulose.

In accordance with the present disclosure, the predetermined amount of mineral clay to the predetermined amount of cellulose derivative has a mass ratio in the range of 1:1 to 1:10, preferably in the range of 1:1 to 1:4.

In an exemplary embodiment, the ratio of the predetermined amount of mineral clay to the predetermined amount of cellulose derivative is 1:2.

In accordance with the present disclosure, the predetermined amount of additive is in the range with respect to 0.1 mass % to 10 mass % with respect to the total mass of the composition.

In an exemplary embodiment, the predetermined amount of additive is 0.1 mass % with respect to the total mass of the composition.

In accordance with the present disclosure, the coupling agent is at least one selected from the group consisting of γ-(Methacryl oxyl) propyl tri methoxy silane and γ-(2, 3-epoxy propoxy) propyl tri methoxy silane.

In an exemplary embodiment, the coupling agent is γ-(Methacryl oxyl) propyl tri methoxy silane.

In another exemplary embodiment, the coupling agent is γ-(2, 3-epoxy propoxy) propyl tri methoxy silane.

In accordance with the present disclosure, the curing agent is at least one selected from the group consisting of peroxide, benzoyl peroxide, lauryl peroxide, 2,2-azo-bis-isobutyrylnitrile and tert-Butyl peroxy benzoate.

In an exemplary embodiment, the curing agent is peroxide.

The resin composition of the present disclosure offers enhanced strength to the articles made from the resin composition.

The additive used in the resin composition increases the binding between the resin and the filler material, therefore a comparatively lesser amount of the resin is required, thereby making the resin composition cost-effective.

The additives in the resin composition assist in a smooth flow of the composition material inside the cast/mould, thus the flow rates are decreased. Additionally, the additive serves as a lubricant, significantly reducing the material filling time for the mould, which is challenging to achieve with conventional materials.

The resin composition of the present disclosure can be used in the preparation of the casted/moulded articles selected from the group consisting of kitchen sinks, wash basins, bathtubs and other moulded articles.

In another aspect, the present disclosure relates to a process for preparing a resin composition.

The process comprises blending a mineral clay with a cellulose derivative in a predetermined ratio to obtain an additive of a predetermined amount.

The predetermined amount of the additive is mixed with a filler, a resin and optionally a coupling agent and a curing agent is added to form a mixture. The mixture is then introduced in a blender and is subsequently subjected to blending at a speed in the range of 100 rpm to 200 rpm for a time period in the range of 10 minutes to 55 minutes to obtain the resin composition.

In accordance with the present disclosure, the mineral clay is at least one selected from the group consisting of magnesium silicate hydrate gel, kaolinite and bentonite.

In an exemplary embodiment, the mineral clay is magnesium silicate hydrate gel.

In accordance with the present disclosure, the cellulose derivative is at least one selected from the group consisting of carboxymethyl cellulose, ethyl cellulose Methyl cellulose, hydroxyethyl cellulose, hydroxypropyl cellulose.

In an exemplary embodiment, the cellulose derivative is carboxymethyl cellulose.

In accordance with the present disclosure, the predetermined amount of mineral clay to the predetermined amount of cellulose derivative has a mass ratio in the range of 1:1 to 1:10, preferably in the range of 1:1 to 1:4.

In an exemplary embodiment, the ratio of the predetermined amount of mineral clay to the predetermined amount of cellulose derivative is 1:2.

In accordance with the present disclosure, the resin is at least one selected from the group consisting of acrylic resin, acrylate resin, epoxy resin, polycarbonate resin, vinyl ester resin, polyamides, polymethylmethacrylate resin and polyester resin.

In an exemplary embodiment, the resin is polymethylmethacrylate resin.

In an exemplary embodiment, the predetermined amount of resin is 5 mass % with respect to the total mass of the composition.

In another exemplary embodiment, the predetermined amount of resin is 10 mass % with respect to the total mass of the composition.

In another exemplary embodiment, the predetermined amount of resin is 20 mass % with respect to the total mass of the composition.

In another exemplary embodiment, the predetermined amount of resin is 30 mass % with respect to the total mass of the composition.

In accordance with the present disclosure, the filler is at least one selected from the group consisting of quartz, olivine, feldspar, pyroxene, mica, granite, ceramics and metals.

In another exemplary embodiment, the filler is quartz.

In an exemplary embodiment, the predetermined amount of the filler is 70 mass % with respect to the total mass of the composition.

In an exemplary embodiment, the predetermined amount of the filler is 75 mass % with respect to the total mass of the composition.

In another exemplary embodiment, the predetermined amount of the filler is 80 mass % with respect to the total mass of the composition.

In an exemplary embodiment, the predetermined amount of the filler is 85 mass % with respect to the total mass of the composition.

In an exemplary embodiment, the predetermined amount of the filler is 90 mass % with respect to the total mass of the composition.

In accordance with the present disclosure, the coupling agent is at least one selected from the group consisting of γ-(Methacryl oxyl) propyl tri methoxy silane and γ-(2, 3-epoxy propoxy) propyl tri methoxy silane.

In an exemplary embodiment, the coupling agent is γ-(Methacryl oxyl) propyl tri methoxy silane.

In another exemplary embodiment, the amount of coupling agent is γ-(2, 3-epoxy propoxy) propyl tri methoxy silane.

In accordance with the present disclosure, the curing agent is at least one selected from the group consisting of peroxide, benzoyl peroxide, lauryl peroxide, 2,2-azo-bis-isobutyrylnitrile and tert-Butyl peroxy benzoate.

In accordance with the present disclosure, the predetermined amount of the additive is in the range with respect to 0.1 mass % to 10 mass % with respect to the total mass of the composition.

In an exemplary embodiment, the predetermined amount of the additive is 0.1 mass %.

In yet another aspect, the present disclosure relates to a process for preparing an article using the resin composition of the present disclosure. The process comprises pouring the resin composition in a hot press mould and heating at a temperature in the range of 170° C. to 190° C. for a time period in the range of 50 minutes to 55 minutes to obtain a preform. Subsequent to obtaining the preform, the preform is removed from the mould, followed by curing at a temperature in the range of 170° C. to 190° C. for a time period in the range of 50 minutes to 60 minutes to obtain the article.

In an exemplary embodiment, the temperature of heating is 170° C.

In an exemplary embodiment, the time period for hot press moulding is 55 minutes.

In an exemplary embodiment, the curing temperature is 170° C.

In an exemplary embodiment, the time period for curing is 55 minutes.

Any deviation from the aforementioned steps may lead to variations in the quality of the resulting resin composition.

The article obtained using the process of the present disclosure is non-porous, more flexible, and harder than many types of natural stone. The article has a uniform internal structure and does not have hidden cracks or flaws that may exist in natural stone and also has a consistency in colour/pattern throughout the article. Further, a variation in colour or obtaining an article with a specific structure was also possible using the composition and the process of the present disclosure. The articles prepared using the resin composition have higher strength, can be moulded with lower thicknesses, while retaining the desired strength, are durable and have enhanced life expectancy, and are weather resistant and eco-friendly.

The foregoing description of the embodiments has been provided for purposes of illustration and is not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

The present disclosure is further described in light of the following experiments which are set forth for illustration purpose only and not to be construed for limiting the scope of the disclosure. The following experiments can be scaled up to industrial/commercial scale and the results obtained can be extrapolated to industrial scale.

### EXPERIMENTAL DETAILS

### Example 1: Process for the Preparation of the Resin Composition and Article Therefrom, in Accordance with the Present Disclosure

A resin composition comprising 0.1% additive, 24% resin and 75.9% filler of the total amount of the material was prepared, as detailed below. The additive consisted of mineral clay to cellulose derivative in the ratio of 1:2.

Additive was prepared by adding 33.3 gm of carboxymethyl cellulose (CMC) and 16.6 gm of magnesium aluminum silicate (mineral clay). The obtained additive was then added to 38 kg of quartz (filler) and 12 kg Poly (methyl methacrylate) resin which was subsequently mixed at 150 rpm for 55 minutes to obtain the resin composition. The total amount of the resin composition that used for casting the article was 50 kg.

The resin composition was characterized by having flowability of 6.5 kg/min.

Further, an article (sink) was prepared using the obtained resin composition. For this, the resin composition was poured in a hot press mould and the temperature of the mould was raised to 180° C. and for 55 minutes to obtain a preform. Thereafter, the preform was cured at a temperature of 170° C. for 55 minutes to obtain the article (sink).

It was observed that the sink had a uniform internal structure and did not have hidden cracks or flaws when compared to an article made out of natural stone.

Further, the sink prepared from the resin composition was tested for mechanical strength, as shown in table 1 below:

TABLE 1
Mechanical strength of article with 0.1% additive and 24% resin

| TRIAL | POT DROP | | | | | | |
|---|---|---|---|---|---|---|---|
| 24% | DROP | | DROP | TEST | TOTAL | | REMARKS |
| resin | HEIGHT | | WEIGHT | RESULT | TEST | REMARKS | OVERALL |
| (1:2CMC:MAS) | 50 | cm | Appr. | No effect | 1 | ok | Article safe up |
| (0.1%) | | | 2 kgs | | | | to 100 to |
| | 60 | cm | Appr. | No effect | 1 | ok | 170 cm. |
| | 70 | cm | 2 kgs | No effect | 1 | ok | |
| | 80 | cm | Appr. | No effect | 1 | ok | |
| | 90 | cm | 2 kgs | No effect | 1 | ok | |
| | 100 | cm | Appr. | No effect | 1 | ok | |
| | 115 | cm | 2 kgs | No effect | 1 | ok | |
| | 135 | cm | Appr. | No effect | 1 | ok | |
| | 150 | cm | 2 kgs | No effect | 1 | ok | |
| | 170 | cm | Appr. | No effect | 1 | ok | |
| | 175 | cm | 2 kgs | Broken | 1 | Broken | |

It was observed that after using 0.1% additive in the composition, the mechanical strength increased of article increased and the article broke at 175 cm.

This strength was higher than that of the article without additives, as shown in table 2 below. For this, an article without additives was prepared using 24% resin and 76% filler. 38 kg of quartz (filler) was added to 12 kg polymethyl methacrylate (PMMA) resin which was subsequently mixed at 150 rpm for 55 minutes to obtain the resin composition, which was poured in a hot press mould. The temperature of the mould was raised to 180° C. and for 55 minutes to obtain a preform. Thereafter, the preform was cured at a temperature of 170° C. for 55 minutes to obtain the article (sink) without additive.

TABLE 2
Mechanical strength of the article with 24% resin and without additive

| | POT DROP TEST | | | | | |
|---|---|---|---|---|---|---|
| | DROP | DROP | TEST | TOTAL | | REMARKS |
| Trial | HEIGHT | WEIGHT | RESULT | TEST | REMARKS | OVER ALL |
| 24% | 50 cm | Appr. 2 | No | 1 | OK | Article |
| Resin | | Kgs | Effect | | | passed up |
| | 60 cm | Appr. 2 | No | 1 | OK | to 90 cm. |
| | | Kgs | Effect | | | |
| | 70 cm | Appr. 2 | No | 1 | OK | |
| | | Kgs | Effect | | | |
| | 80 cm | Appr. 2 | No | 1 | OK | |
| | | Kgs | Effect | | | |
| | 90 cm | Appr. 2 | No | 1 | OK | |
| | | Kgs | Effect | | | |
| Edge | 100 cm | Appr. 2 | Sink | 1 | Broken | |
| Thickness: | | Kgs | Broken | | | |

### Example 2: Preparation of the Resin Composition with Variation in Additive Percentage, in Accordance with the Present Disclosure

Further, various resin compositions were prepared as per the process described in example 1, except that the additive percentages were varied, as shown in table 3 below

TABLE 3
Mechanical strengths of article with variation in
additive % keeping resin % constant (24% resin)

| S. | | CMC | MAS | | |
|---|---|---|---|---|---|
| No | Additive(%) | (gm) | (gm) | Pot-Drop Test | Flowability |
| 1. | 0.2 | 67 | 33 | Up to 170 cm to 180 cm | 6.3 to 6.9 |
| 2. | 0.5 | 167.5 | 82.5 | Up to 170 cm to 200 cm | 6.3 to 7.2 |
| 3. | 1 | 335 | 165 | Up to 180 cm to 218 cm | 6.3 to 7.4 |
| 4. | 2 | 750 | 250 | Up to 190 cm to 230 cm | 6.3 to 7.8 |
| 5. | 4 | 1.5 | 500 | Up to 200 cm to 250 cm | 6.3 to 7.9 |
| 6. | 5 | 2 | 500 | Up to 200 cm to 270 cm | 6.3 to 8.05 |

It was observed that with increase in the percentage of additive there was increase in the flowability of the resin composition. An increase in the mechanical strength was also observed with increase in the percentage of additive in the resin composition.

### Example 3: Preparation of the Resin Composition with Variation in the Resin Percentage, in Accordance with the Present Disclosure

Various resin compositions were prepared following the process outlined in Example 1, with different combinations of resin and additive percentages. The resulting articles were subjected to mechanical strength testing.

The results for increase in the mechanical strengths are provided in the below table 4

TABLE 4
Mechanical strengths of article with
variation in resin % and additive %

| | | Mechanical strength of the | |
|---|---|---|---|
| Sr. No. | Additive % | article | Resin % |
| 1 | 1.5 | Article safe up to 150 cm to | 20 to 30% |
| 2 | 2 | 270 cm | |
| 3 | 4 | | |
| 4 | 6 | Article safe up to 100 cm to | 10 to 20% |
| 5 | 7.5 | 180 cm | |
| 6 | 9 | | |
| 7 | 9.5 | | |

It was observed that reducing the resin percentage in the article led to a decline in its mechanical strength. Nevertheless, the use of additives resulted in notable improvements in the article's mechanical strength and flowability.

Further, it was noticed that if the resin content exceeded 30% during casting with these additives, defects occurred at the bonding interface between the resin, additives and filler particles due to polymerization shrinkage stress during curing.

On the other hand, using less than 5% resin with these additives had challenges in effectively binding filler particles of the same size to cast the article.

It was also observed that when additives were used in a higher proportion than claimed, there was a decrease in the mechanical strength,

It was further observed, when using smaller particle size fillers less than 0.06 mm, morphological defects appeared on the article's surface, resulting in an unnatural appearance. Further, if the particle size of the filler particles, particularly those of quartz are greater than 0.8 mm, the binding with the resin in the resin composition and the final article is not uniform and not satisfactory. Ideally therefore, the particle size of the fillers, particularly quartz fillers should be in the range of greater than 0.06 mm and less than 0.8 mm. It was also observed that an optimum appearance and strength properties were achieved in the cast article when fillers in different particle size ranges were used. Typically, the ranges of the particle size lay between 0.6 mm to 0.1 mm, 0.1 mm to 0.3 mm, 0.3 mm to 0.7 mm.

Additionally, it was noticed that the mechanical strength of the article decreases with a reduction in resin percentage, as shown in table 5 below. However, even with this decrease, the mechanical strength remains superior to that of an article prepared without the addition of the additive (mechanical strength of the additive-free article, which was recorded at 90 cm).

TABLE 5
Mechanical strengths of article with reduced resin percentages

| Sr. | | | Enhancement in |
|---|---|---|---|
| No. | Resin % | Additive % | mechanical strength |
| 1 | 20 to 30% | 0.1 to 5% | 100 cm to 270 cm |
| 2 | 15 to 20% | 5 to 7% | 100 cm to 135 cm |
| 3 | 10 to 15% | 7 to 10% | 100 cm to 120 cm |

### Example 4: Preparation of the Resin Compositions in Accordance with the Present Disclosure and Testing for Pot Drop and Ball Drop Tests

Different resin composition was prepared using the process as disclosed in example 1, except that the resin quantity used was 15%, 18% and 20%. Articles were prepared using the obtained compositions and were further subjected to pot drop and ball drop tests. The results obtained were as follows:

TABLE 6
Pot drop and ball drop test results containing 15% resin
in the composition used for the preparation of article

| Article | Drop | | Drop | Test | Total | | |
|---|---|---|---|---|---|---|---|
| No. | Height | | Weight | Result | Test | Remarks | Remarks |
| 1 | 50 | cm | ~2 kg | No Effect | 1 | OK | Article |
| 2 | 60 | cm | ~2 kg | No Effect | 1 | OK | Passed up |
| 3 | 70 | cm | ~2 kg | No Effect | 1 | OK | to 115 |
| 4 | 80 | cm | ~2 kg | No Effect | 1 | OK | cms |
| 5 | 90 | cm | ~2 kg | No Effect | 1 | OK | |
| 6 | 100 | cm | ~2 kg | No Effect | 1 | OK | |
| 7 | 115 | cm | ~2 kg | No Effect | 1 | OK | |
| 8 | 125 | cm | ~2 kg | Broken | 1 | OK | |

TABLE 7
Pot drop and ball drop test results containing 18% resin
in the composition used for the preparation of article

| Article | Drop | | Drop | Test | Total | | |
|---|---|---|---|---|---|---|---|
| No. | Height | | Weight | Result | Test | Remarks | Remarks |
| 1 | 50 | cm | ~2 kg | No Effect | 1 | OK | Article |
| 2 | 60 | cm | ~2 kg | No Effect | 1 | OK | Passed up |
| 3 | 70 | cm | ~2 kg | No Effect | 1 | OK | to 117 |
| 4 | 80 | cm | ~2 kg | No Effect | 1 | OK | cms |
| 5 | 90 | cm | ~2 kg | No Effect | 1 | OK | |
| 6 | 100 | cm | ~2 kg | No Effect | 1 | OK | |
| 7 | 117 | cm | ~2 kg | No Effect | 1 | OK | |
| 8 | 130 | cm | ~2 kg | Sink | 1 | Broken | |
| | | | | broken | | | |

TABLE 8
Pot drop and ball drop test results containing 20% resin
in the composition used for the preparation of article

| Article | Drop | | Drop | Test | Total | | |
|---|---|---|---|---|---|---|---|
| No. | Height | | Weight | Result | Test | Remarks | Remarks |
| 1 | 50 | cm | ~2 kg | No Effect | 1 | OK | Article |
| 2 | 60 | cm | ~2 kg | ″ | 1 | OK | passed up |
| 3 | 70 | cm | ~2 kg | No Effect | 1 | OK | to 172 |
| 4 | 80 | cm | ~2 kg | No Effect | 1 | OK | cms |
| 5 | 90 | cm | ~2 kg | No Effect | 1 | OK | |
| 6 | 125 | cm | ~2 kg | No Effect | 1 | OK | |
| 7 | 153 | cm | ~2 kg | No Effect | 1 | OK | |
| 8 | 172 | cm | ~2 kg | No Effect | 1 | OK | |
| 9 | 175 | cm | ~2 kg | Sink | 1 | Broken | |
| | | | | broken | | | |

It can be seen from the above tables 6 to 8 that as resin percentage decreased a decrease in mechanical strength was observed.

### Example 5: Comparative Example

Experiments were performed wherein resin compositions were prepared in which only cellulose derivative was used as an additive and only mineral clay as an additive.

The inclusion of only cellulose derivative as an additive exhibited 5% to 15% enhancement in mechanical strength while reducing the required resin quantity by 6% to 10% in the total amount of the composition. Moreover, the addition of cellulose derivative increased the flowability by 10% to 40%. It was further observed that using only cellulose derivative in the composition resulted in safety up to 100 to 105 cm in the pot-drop test.

TABLE 9
Pot drop test of article prepared from the resin composition
prepared containing only cellulose derivative

| | | POT DROP TEST | | | | | | |
|---|---|---|---|---|---|---|---|---|
| S. NO | | Drop | | Drop | | Total | | |
| No. | TRIAL | Height | | Weight | Test Result | Test | Remarks | Remarks |
| 1 | 20% | 50 | cm | ~2 kg | No Effect | 1 | OK | Article |
| | resin | | | | | | | Passed up to |
| | Only | 60 | cm | ~2 kg | No Effect | 1 | OK | 100to105 cm. |
| | cellulose | | | | | | | |
| | derivative | | | | | | | |
| | (6%) | | | | | | | |
| | | 70 | cm | ~2 kg | No Effect | 1 | OK | |
| | | 80 | cm | ~2 kg | No Effect | 1 | OK | |
| | | 90 | cm | ~2 kg | No Effect | 1 | OK | |
| | | 100 | cm | ~2 kg | No Effect | 1 | OK | |
| | | 105 | cm | ~2 kg | No Effect | 1 | OK | |
| | Edge | 110 | cm | ~2 kg | Broken | 1 | Broken | |
| | thickness | | | | | | | |

It is also observed from table 10 below, that the addition of only the mineral clay as an additive gave 10% to 30% enhancement in the mechanical strength and a decrease of 3% to 10% in the required resin quantity in the total amount of the resin composition. Further, the addition of only the mineral clay as an additive increased the flowability by 10% to 40%. The hydrated mineral clay dispersion contains many silanol groups which have a high potential to form bonds with oxygen atoms of carboxyl, hydroxyl and ester groups of the resin polymer which increased the binding property.

TABLE 10
Pot drop test of article prepared from the resin
composition prepared containing only mineral clay

| | | POT DROP TEST | | | | | | |
|---|---|---|---|---|---|---|---|---|
| S. NO | | Drop | | Drop | | Total | | |
| No. | TRIAL | Height | | Weight | Test Result | Test | Remarks | Remarks |
| 1 | 23% | 50 | cm | ~2 kg | No Effect | 1 | OK | Article |
| | resin | | | | | | | Passed up to |
| | Only | 60 | cm | ~2 kg | No Effect | 1 | OK | 100to120 cm. |
| | Mineral | | | | | | | |
| | clay (6%) | | | | | | | |
| | | 70 | cm | ~2 kg | No Effect | 1 | OK | |
| | | 80 | cm | ~2 kg | No Effect | 1 | OK | |
| | | 90 | cm | ~2 kg | No Effect | 1 | OK | |
| | | 100 | cm | ~2 kg | No Effect | 1 | OK | |
| | | 115 | cm | ~2 kg | No Effect | 1 | OK | |
| | Edge | 120 | cm | ~2 kg | Broken | 1 | Broken | |
| | thickness | | | | | | | |

It was observed that using only the mineral clay in the composition resulted in safety up to 100 cm to 130 cm in pot-drop test. Additionally, it led to a decrease in resin by 3 to 7% of the total casting material and a significant increase in flow ability by 10 to 40%.

The hydrated mineral clay dispersion contains numerous silanol groups that have a high potential to form bonds with oxygen atoms of carboxyl, hydroxyl and ester groups in this polymer, potentially enhancing its binding properties.

When using cellulose derivative and hydrated mineral clay in the ratio of 2:1 to 4:1, it was observed that there was a significant improvement in mechanical strength by 30 to 80%. Additionally, the resin content decreased by 15-20% of the total material, while the flow ability increased by 10 to 50%.

When cellulose derivative and hydrated mineral clay were used in the range of 1:2 to 1:4, it is observed that there is a significant enhancement in mechanical strength by 30 to 60%. Additionally, the resin content decreases by 13 to 18% of the total material and the flow ability also increases by 10 to 50%.

Furthermore, there is an improvement in the agglomeration of the material. Consequently, the binding property also exhibited better performance. This observation indicates that the dispersed hydrated mineral clay and cellulose derivative possibly function as cross-linkers with the resin and other additives, creating numerous points of contact.

### Technical Advances and Economic Significance

The present disclosure described herein above has several technical advantages including, but not limited to, the realization of a resin composition, that:
is easy to prepare;
requires a lesser amount of resin;
is cost-effective and environment-friendly;
has higher mechanical strength;
improves the flow of materials to the mould,

a process for the preparation of the resin composition:
is simple, economic and environment friendly;
   AND

articles prepared using the resin composition, that:
have higher strength;
can be moulded with lower thicknesses, while retaining the desired strength;
is durable and have enhanced life expectancy;
is weather resistant; and
is eco-friendly.

The major benefit in these resin articles is that they not only resemble the natural stone articles to a greater extent but also have significantly improved strengths. The resin composition has better mouldability and hence, the process of preparation of the article becomes easier and simpler. Further, the process in accordance with the present disclosure is highly productive, has lower capital and operating costs.

Further, the resin composition of the present disclosure can be used for preparing surfaces or articles by casting or moulding. Further, other inorganic and/or organic fillers, pigments and other additives can also be added to the resin composition to enhance the aesthetics.

THROUGHOUT THIS SPECIFICATION THE WORD “COMPRISE”, OR VARIATIONS SUCH AS—“COMPRISES” OR “COMPRISING”, WILL BE UNDERSTOOD TO IMPLY THE INCLUSION OF A STATED ELEMENT, INTEGER OR STEP, OR GROUP OF ELEMENTS, INTEGERS OR STEPS, BUT NOT THE EXCLUSION OF ANY OTHER ELEMENT, INTEGER OR STEP, OR GROUP OF ELEMENTS, INTEGERS OR STEPS.

THE USE OF THE EXPRESSION “AT LEAST” OR “AT LEAST ONE” SUGGESTS THE USE OF ONE OR MORE ELEMENTS OR INGREDIENTS OR QUANTITIES, AS THE USE MAY BE IN THE EMBODIMENT OF THE DISCLOSURE TO ACHIEVE ONE OR MORE OF THE DESIRED OBJECTS OR RESULTS.

ANY DISCUSSION OF DOCUMENTS, ACTS, MATERIALS, DEVICES, ARTICLES OR THE LIKE THAT HAS BEEN INCLUDED IN THIS SPECIFICATION IS SOLELY FOR THE PURPOSE OF PROVIDING A CONTEXT FOR THE DISCLOSURE. IT IS NOT TO BE TAKEN AS AN ADMISSION THAT ANY OR ALL OF THESE MATTERS FORM A PART OF THE PRIOR ART BASE OR WERE COMMON GENERAL KNOWLEDGE IN THE FIELD RELEVANT TO THE DISCLOSURE AS IT EXISTED ANYWHERE BEFORE THE PRIORITY DATE OF THIS APPLICATION.

THE NUMERICAL VALUES MENTIONED FOR THE VARIOUS PHYSICAL PARAMETERS, DIMENSIONS OR QUANTITIES ARE ONLY APPROXIMATIONS AND IT IS ENVISAGED THAT THE VALUES HIGHER/LOWER THAN THE NUMERICAL VALUES ASSIGNED TO THE PARAMETERS, DIMENSIONS OR QUANTITIES FALL WITHIN THE SCOPE OF THE DISCLOSURE, UNLESS THERE IS A STATEMENT IN THE SPECIFICATION SPECIFIC TO THE CONTRARY.

WHILE CONSIDERABLE EMPHASIS HAS BEEN PLACED HEREIN ON THE COMPONENTS AND COMPONENT PARTS OF THE PREFERRED EMBODIMENTS, IT WILL BE APPRECIATED THAT MANY EMBODIMENTS CAN BE MADE AND THAT MANY CHANGES CAN BE MADE IN THE PREFERRED EMBODIMENTS WITHOUT DEPARTING FROM THE PRINCIPLES OF THE DISCLOSURE. THESE AND OTHER CHANGES IN THE PREFERRED EMBODIMENT AS WELL AS OTHER EMBODIMENTS OF THE DISCLOSURE WILL BE APPARENT TO THOSE SKILLED IN THE ART FROM THE DISCLOSURE HEREIN, WHEREBY IT IS TO BE DISTINCTLY UNDERSTOOD THAT THE FOREGOING DESCRIPTIVE MATTER IS TO BE INTERPRETED MERELY AS ILLUSTRATIVE OF THE DISCLOSURE AND NOT AS A LIMITATION.

1. A resin composition comprising:
a) a resin in an amount in the range of 5 mass % to 30 mass % with respect to the total mass of said composition;
b) a filler in an amount in the range of 70 mass % to 90 mass % with respect to the total mass of said composition;
c) an additive in an amount in the range of 0.1 mass % to 10 mass % with respect to the total mass of said composition, wherein said additive comprises a predetermined amount of a mineral clay and a predetermined amount of a cellulose derivative;
d) optionally a coupling agent in an amount in the range of 0.5 mass % to 3 mass % with respect to the total mass of said composition; and
e) optionally a curing agent in an amount in the range of 0.02 mass % to 0.09 mass % with respect to the total mass of said composition.

2. The composition as claimed in claim 1, wherein said resin is at least one selected from the group consisting of acrylic resin, epoxy resin, polycarbonate resin, vinyl ester resin, polyamide resin, polymethylmethacrylate resin and polyester resin.

3. The composition as claimed in claim 1, wherein said filler is at least one selected from the group consisting of quartz, olivine, feldspar, pyroxene, mica, granite, ceramics and metals.

4. The composition as claimed in claim 3, wherein said filler is in the form of particles and predominant quantity of the particles have a particle size in the range of 0.06 mm to 0.8 mm.

5. The composition as claimed in claim 3, wherein said filler is in the form of particles and predominant quantity of the particles have particle size in the ranges of 0.06 mm to 0.1 mm, 0.1 mm to 0.3 mm and 0.3 mm to 0.7 mm.

6. The composition as claimed in claim 1, wherein said mineral clay is at least one clay selected from the group consisting of magnesium silicate hydrate gel, kaolinite and bentonite.

7. The composition as claimed in claim 1, wherein said cellulose derivative is at least one derivative selected from the group consisting of ethyl cellulose, methyl cellulose, carboxymethyl cellulose, hydroxyethyl cellulose and hydroxypropyl cellulose.

8. The composition as claimed in claim 1, wherein said coupling agent is at least one agent selected from the group consisting of γ-(Methacryl oxyl) propyl tri methoxy silane and γ-(2, 3-epoxy propoxy) propyl tri methoxy silane.

9. The composition as claimed in claim 1, wherein said curing agent is at least one agent selected from the group consisting of peroxide, benzoyl peroxide, lauryl peroxide, 2,2-azo-bis-isobutyrylnitrile and tert-Butyl peroxy benzoate.

10. The composition as claimed in claim 1, wherein said predetermined amount of mineral clay to said predetermined amount of cellulose derivative has a mass ratio in the range of 1:1 to 1:10.

11. The composition as claimed in claim 1, wherein said predetermined amount of mineral clay to said predetermined amount of cellulose derivative has a mass ratio in the range of 1:1 to 1:4.

12. The composition as claimed in claim 1, which is characterized by having flowability in the range of 6.0 kg/min to 9.0 kg/min.

13. The composition as claimed in claim 1, which is characterized by having mechanical strength measured by the pot drop test wherein an article made from the composition resists breaking from a height of upto 270 cm.

14. A process for preparing a resin composition, said process comprising the following steps:
a. blending a mineral clay and a cellulose derivative in a predetermined mass ratio to obtain an additive of a predetermined amount; and
b. mixing said predetermined amount of said additive with a filler, a resin and optionally adding a coupling agent and a curing agent to form a mixture; and
c. introducing said mixture in a blender and blending at a speed in the range of 100 rpm to 200 rpm for a time period in the range of 10 minutes to 55 minutes to obtain the resin composition.

15. The process as claimed in claim 14, wherein
i. said mineral clay is at least one selected from the group consisting of magnesium silicate hydrate gel, kaolinite and bentonite
ii. said cellulose derivative is at least one selected from the group consisting of ethyl cellulose, methyl cellulose, carboxymethyl cellulose, hydroxyethyl cellulose and hydroxypropyl cellulose.
iii. said resin is at least one selected from the group consisting of acrylic resin, acrylate resin, epoxy resin, polycarbonate resin, vinyl ester resin, polyamides, polymethylmethacrylate resin and polyester resin;
iv. said filler is at least one selected from the group consisting of quartz, olivine, feldspar, pyroxene, mica, granite, ceramics and metals;
v. said coupling agent is at least one selected from the group consisting of γ-(Methacryl oxyl) propyl tri methoxy silane and γ-(2, 3-epoxy propoxy) propyl tri methoxy silane; and
vi. said curing agent is at least one selected from the group consisting of peroxide, benzoyl peroxide, lauryl peroxide, 2,2-azo-bis-isobutyrylnitrile and tert-Butyl peroxy benzoate.

16. The process as claimed in claim 14, wherein
(i) said predetermined mass ratio of said mineral clay to said cellulose derivative is in the range of 1:1 to 1:10;
(ii) said predetermined amount of said resin is in the range of 5 mass % to 30 mass % with respect to the total mass of said composition;
(iii) said predetermined amount of said filler is in the range of 70 mass % to 90 mass % with respect to the total mass of said composition;
(iv) said predetermined amount of said additive is in the range of 0.1 mass % to 5 mass % with respect to the total mass of said composition;
(v) said predetermined amount of said coupling agent is in the range of 0.5 mass % to 3 mass % with respect to the total mass of said composition; and
(vi) said predetermined amount of said curing agent is in the range of 0.02 mass % to 0.09 mass % with respect to the total mass of said composition.

17. A process for preparing an article using the resin composition as claimed in claim 1, said process comprises the following steps:
a. pouring said composition in a hot press mould and heating at a temperature in the range of 170° C. to 190° C. for a time period in the range of 50 minutes to 55 minutes to obtain a preform; and
b. removing said preform from the mould, followed by curing at a temperature in the range of 170° C. to 190° C. for a time period in the range of 50 minutes to 60 minutes to obtain the article.
